(19) United States
(12) Patent Application Publication
(10) Pub. No.: US 2013/0188530 A1
(43) Pub. Date: Jul. 25, 2013

(54) Full-Duplex Deployment In Wireless Communications

(71) Applicants: Juho Mikko Oskari Pirskanen, Kangasala (FI); Sami-Jukka Hakola, Kempele (FI); Juha P. Karjalainen, Olu (FI); Timo K. Koskela, Oulu (FI); Samuli Turtinen, Ii (FI)

(72) Inventors: Juho Mikko Oskari Pirskanen, Kangasala (FI); Sami-Jukka Hakola, Kempele (FI); Juha P. Karjalainen, Olu (FI); Timo K. Koskela, Oulu (FI); Samuli Turtinen, Ii (FI)

(73) Assignee: Renesas Mobile Corporation

(21) Appl. No.: 13/363,596

(22) Filed: Feb. 1, 2012

(30) Foreign Application Priority Data
Jan. 20, 2012 (GB) 1200962.7

(51) Int. Cl. H04J 3/00

(52) U.S. Cl. 370/280

(57) ABSTRACT

The specification and drawings present a new method, apparatus and software related product (e.g., a computer readable memory) for configuring/implementing by a network/network element a partial full-duplex in time dependent operational mode for wireless communications between UEs and the network/network element, e.g., in LTE systems. The time dependent partial full-duplex may further include bandwidth allocations for the full-duplex and half-duplex time intervals. In the half-duplex time periods, undesirable interference and self-interference effects during signal detection by the UEs and/or eNBs may be reduced to an advantage. The network may configure a time dependence of the partial full-duplex operational mode for wireless communications between UEs and the network, wherein during at least one time interval the network configures a full-duplex operational mode and during at least one other time interval the network configures a half-duplex operational mode for the wireless communications between the UEs and the network.

### TECHNICAL FIELD

The exemplary and non-limiting embodiments of this invention relate generally to wireless communications and more specifically to utilizing a partial full-duplex in a time dependent operational mode in wireless communications, e.g., in LTE systems.

### BACKGROUND ART

The following abbreviations that may be found in the specification and/or the drawing figures are defined as follows:

3GPP 3^{rd} generation partnership project

BTS base transceiver station

D2D device-to-device

DL downlink

E-UTRA evolved universal terrestrial radio access

eNB, eNodeB evolved node B /base station in an E-UTRAN system

E-UTRAN evolved UTRAN (LTE)

GSM global system for mobile communications

LTE long term evolution

LTE-A long term evolution advanced

MTC machine type communication

RRC radio resource control

Rx, RX reception, receiver

Tx, TX transmission, transmitter

TTI transmission time interval

UE user equipment

UP uplink

UTRAN universal terrestrial radio access network

Recently, full-duplex communications have attracted a lot of interest to enhance spectral efficiency in local area communications. The full-duplex communications are based on the principle in which radios can transmit and receive simultaneously on the same frequency band resulting in a self-interference problem. The self-interference problem is mainly caused by the large imbalance between the transmitted signal power and received signal power. Typically, the transmitted signal power can be a few orders of magnitude larger than the received signal power. As a result, the received signal may be severely degraded by its own transmitted signal.

General background for the recent full duplex studies can be found from the following references:
Jung II Choi, Mayank Jainy, Kannan Srinivasany, Philip Levis, Sachin Katti, “Achieving Single Channel, Full Duplex Wireless Communication”, In the Proceedings of the 16th Annual International Conference on Mobile Computing and Networking (Mobicom, held Chicago, Ill., USA, Sep. 20-24, 2010);
Melissa Duarte and Ashutosh Sabharwal, “Full-Duplex Wireless Communications Using Off-The-Shelf Radios: Feasibility and First Results”, in the Proceedings of the 44^{th} annual Asilomar conference on signals, systems, and computers (held in Nov. 7-10, 2010 in Monterey, Calif., USA);
Melissa Duarte, Chris Dick and Ashutosh Sabharwal “Experiment-driven Characterization of Full-Duplex Wireless Systems”, Submitted to IEEE Transactions on Wireless Communications, July 2011; (The paper can be found in the following link: http://arxiv.org/abs/1107.1276);
Evan Everett, Melissa Duarte, Chris Dick, and Ashutosh Sabharwal “Empowering Full-Duplex Wireless Communication by Exploiting Directional Diversity”, accepted to the 45^{th} annual Asilomar conference on signals, systems, and computers (held in Nov. 7-10, 2010 in Monterey, Calif., USA); and
Achaleshwar Sahai, Gaurav Patel and Ashutosh Sabharwal “Pushing the limits of Full-duplex: Design and Real-time Implementation”, Rice University technical report TREE1104, February 2011. (The paper can be found in the following link: http://warp.rice.edu/trac/wiki/TechReport2011_FullDuplex)

It may be assumed that in future cellular networks access points and devices will support full-duplex transmission. However, due to the different types of devices on the market, not all of the devices may support full-duplex transmission due to the cost issue (e.g., low capability phones) or the pre-determined service/traffic type (e.g. MTC-devices).

For the overall system performance point of view it would be beneficial to support full duplex for the so-called high end, high transmission capability devices which require such transmission scheme for their current services and at the same time support the non-full-duplex devices.

### SUMMARY

According to a first aspect of the invention, a method comprising: configuring by a network a time dependence of a partial full-duplex operational mode for wireless communications between user equipments and the network, wherein during at least one time interval the network configures a full-duplex operational mode and during at least one other time interval the network configures a half-duplex operational mode for the wireless communications between the user equipments and the network; and communicating with the user equipments using the time dependence of the partial full-duplex operational mode.

According to a second aspect of the invention, an apparatus comprises: at least one processor and a memory storing a set of computer instructions, in which the processor and the memory storing the computer instructions are configured to cause the apparatus to: configure a time dependence of a partial full-duplex operational mode for wireless communications between user equipments and a network, wherein during at least one time interval the apparatus configures a full-duplex operational mode and during at least one other time interval the apparatus configures a half-duplex operational mode for the wireless communications between the user equipments and the network; and communicate with the user equipments using the time dependence of the partial full-duplex operational mode.

According to a third aspect of the invention, a computer readable medium comprising a set of instructions, which, when executed on an apparatus in a network causes the apparatus to perform the steps of: configuring a time dependence of a partial full-duplex operational mode for wireless communications between user equipments and the network, wherein during at least one time interval the apparatus configures a full-duplex operational mode and during at least one other time interval the apparatus configures a half-duplex operational mode for the wireless communications between the user equipments and the network; and communicating with the user equipments using the time dependence of the partial full-duplex operational mode.

According to a third aspect of the invention, an apparatus, comprising: means for configuring a time dependence of a partial full-duplex operational mode for wireless communications between user equipments and a network, wherein during at least one time interval the means for configuring configures a full-duplex operational mode and during at least one other time interval the means for configuring configures a half-duplex operational mode for the wireless communications between the user equipments and the network; and means for communicating with the user equipments using the time dependence of the partial full-duplex operational mode.

### BRIEF DESCRIPTION OF THE DRAWINGS

For a better understanding of the nature and objects of the present invention, reference is made to the following detailed description taken in conjunction with the following drawings, in which:

FIG. 1 is a time domain diagram demonstrating deployment for a time dependent partial full-duplex operation, according to exemplary embodiments of the invention;

FIG. 2 is a frequency diagram demonstrating bandwidth deployment for a time dependent partial full-duplex operation, according to exemplary embodiments of the invention;

FIG. 3 is a flow chart demonstrating implementation of exemplary embodiments of the invention performed by a network element (e.g., eNB); and

FIG. 4 is a block diagram of wireless devices for practicing exemplary embodiments of the invention.

### DETAILED DESCRIPTION

A new method, apparatus, and software related product (e.g., a computer readable memory) are presented for configuring/implementing by a network/network element a partial full-duplex in time dependent operational mode for wireless communications between UEs and the network/network element, e.g., in LTE systems. The time dependent partial full-duplex may further include bandwidth allocations for the full-duplex and half-duplex time intervals. In the half-duplex time periods, undesirable interference and self-interference effects during signal detection by the UEs and/or eNBs may be reduced to an advantage.

According to one embodiment the network may configure a time dependence of the partial full-duplex operational mode for wireless communications between UEs and the network, wherein during at least one time interval the network configures a full-duplex operational mode and during at least one other time interval the network configures a half-duplex operational mode for the wireless communications between the UEs and the network. Then the network may communicate with the UEs using the time dependence of the operational mode.

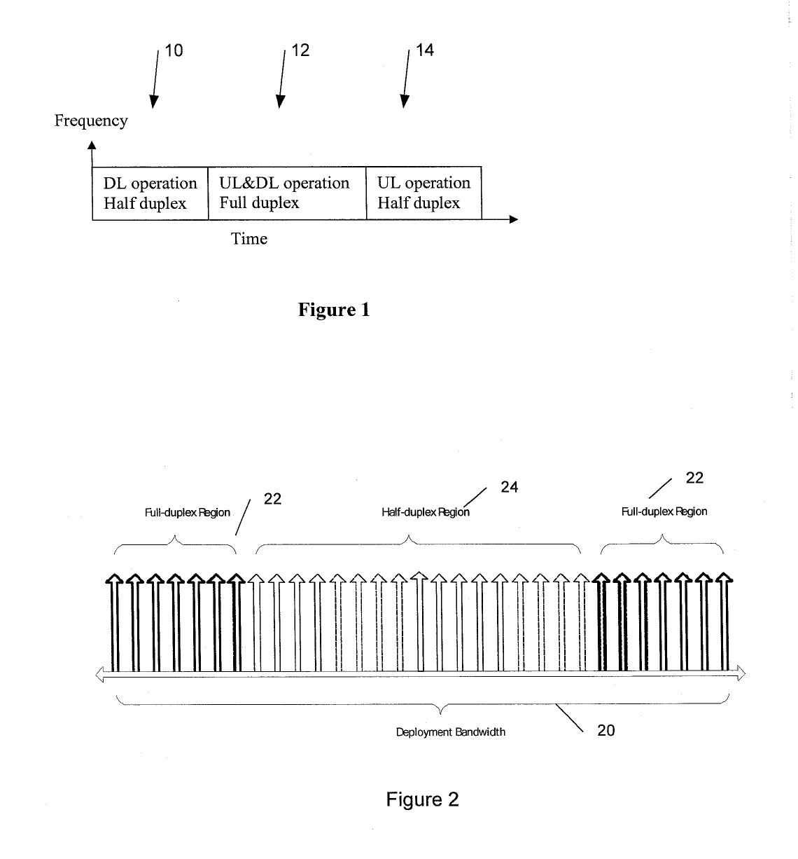

FIG. 1 shows a time domain diagram demonstrating deployment for a time dependent partial full-duplex operation, according to exemplary embodiments of the invention, where during some time periods the system operates in half-duplex operational mode and during other time periods in full-duplex operational mode. In the example of FIG. 1 the DL half-duplex operation period 10 is followed by the UL plus DL full-duplex operation period 12 which is further followed by the UL half-duplex operation period 14. The full-duplex and half-duplex time periods may have the same or different time durations (e.g., using different number of TTIs for the full-duplex and half: duplex time periods). Also a transmitting power level may be different during the full-duplex and half-duplex time periods.

Furthermore, the network may further configure one or more frequency bands for the wireless communications for full-duplex and half-duplex operational modes. For example, the one or more frequency bands may comprise a deployment bandwidth or an allocated region of the deployment bandwidth of the wireless communications between the UEs and the network.

For example, during the at least one time interval the network may configure the full-duplex operational mode for a first frequency band and during the at least one other time interval the network may configure the half-duplex operational mode for a second frequency band, wherein the second frequency band is different than the first frequency band. For example, the second frequency band for the half-duplex operational mode may be broader (i.e., providing a larger resource capability) than the first frequency band, which may allow to reduce the power consumption in the UEs.

FIG. 2 shows a frequency diagram demonstrating bandwidth deployment for a time dependent partial full-duplex operation, according to exemplary embodiments of the invention, As illustrated in the exemplary FIG. 2, the full-duplex regions 22 are located at edges of the deployment bandwidth 20 and the half-duplex region 24 is located in the middle of the deployment bandwidth 20. Therefore, one of the full duplex regions 22 may be used during the at least one time interval for the full-duplex operational mode, and the half-duplex region 24 may be used during the at least one other time interval for the half-duplex operational mode. It is noted that FIG. 2 illustrates only one frequency deployment example and many variations are possible. For example, the half-duplex regions may be located at the edges of the deployment bandwidth 20 with the full-duplex regions in the middle. Also, the deployment bandwidth may comprise a plurality of the full-duplex regions and/or a plurality of the half-duplex regions. In general, the deployment bandwidth may comprise one or more full-duplex regions and/or one or more half-duplex regions at arbitrary positions in the deployment bandwidth.

According to another embodiment, the time dependence of the partial full-duplex operational mode for the wireless communications (with the full-duplex operational mode periods and the half-duplex operational mode periods) may be configured for an eNB of the network for communicating with the UEs in a cell. Also the time dependence of the partial full-duplex operational mode for the wireless communications (with the full-duplex operational mode periods and the half-duplex operational mode periods) may be configured for one or more UEs communicating with the network, e.g., with the eNB. In general only the eNB, or only the UEs, or both the eNB and the UEs (e.g., all or selected UEs in the cell) can be configured for the time dependent partial full-duplex operation.

The network may configure the time dependent partial full-duplex operation (possibly including bandwidth allocations for the full-duplex and half-duplex periods) for the UEs via system information.

Furthermore, the network has to provide an appropriate level of reliability and detection capability in an environment with a variety of interference signals. Using the half-duplex operational mode during the half-duplex time periods can reduce interference (e.g., UE-UE interference and/or self-interference), especially if the detected signal is weak, for exampled for the UE near cell boundary receiving DL signals. The half-duplex time periods would most likely be preferred for operating such remote UE at least for the DL reception of a relatively weak signals (e.g., below a preset threshold). For example, the network may configure the half-duplex operational mode for one or more UEs or for all UEs in a cell during receiving the DL signals if the one or more user equipments in the cell are closer than a predefined distance to a cell boundary.

Addition of the full-duplex operation for the UEs is easier when transmission powers of the UEs are smaller (causing less self-interference), therefore it could be more feasible to use full-duplex in a cell center area than in a cell boarder area. The UEs in the center cell area could utilize a partial full-duplex in time domain and the UEs which are closer to the cell boarder may be half-duplex. For example, during at least one time interval the network may configure a full-duplex operational mode for a portion of the UEs comprised in a cell and located more than a predefined distance from a cell boundary, and a half-duplex operational mode for a remaining portion of the UEs comprised in the cell and located less than a predefined distance from the cell boundary.

In a further embodiment, the network may configure the half-duplex operational mode for the UEs during receiving by the UEs (e.g., from the network) important information such as scheduling information for next one or more frames.

If the network supports both half-duplex UEs/terminals (e.g., legacy UEs) and full-duplex UEs, it would be quite beneficial to divide those in time domain and allow larger bandwidth. At least one benefit of such operation is terminal power consumption as half-duplex UEs could sleep full duplex time periods completely and have larger bandwidth during TX/RX times. This would reduce a duration of the half-duplex TX/RX compared to a frequency division between half-duplex and full-duplex devices. The same benefit can be also available for the full-duplex devices as they would sleep half-duplex system operation times and get a larger instantaneous bandwidth.

For example, during the at least one time interval the network may configure the full-duplex operational mode for one group of UEs using a first frequency band and a sleeping mode of operation for a further group of half-duplex UEs. Then during the at least one other time interval the network can configure in a frequency band broader than the first frequency band the half-duplex operational mode for the first group of the UEs and for the further group of the half-duplex UEs (in non-sleeping mode of operation). The transmitting and receiving periods of the one group of the user equipments may coincide with corresponding transmitting and receiving periods of the further group of the half-duplex user equipments to minimize signal interference.

FIG. 2 shows an exemplary flow chart demonstrating configuring by the network a time dependence of an operational mode (full-duplex or half-duplex) for wireless communications between UEs and a network according to exemplary embodiments disclosed herein. It is noted that certain steps may be skipped, different steps may be added or substituted, or selected step/steps or groups of steps may be performed separately.

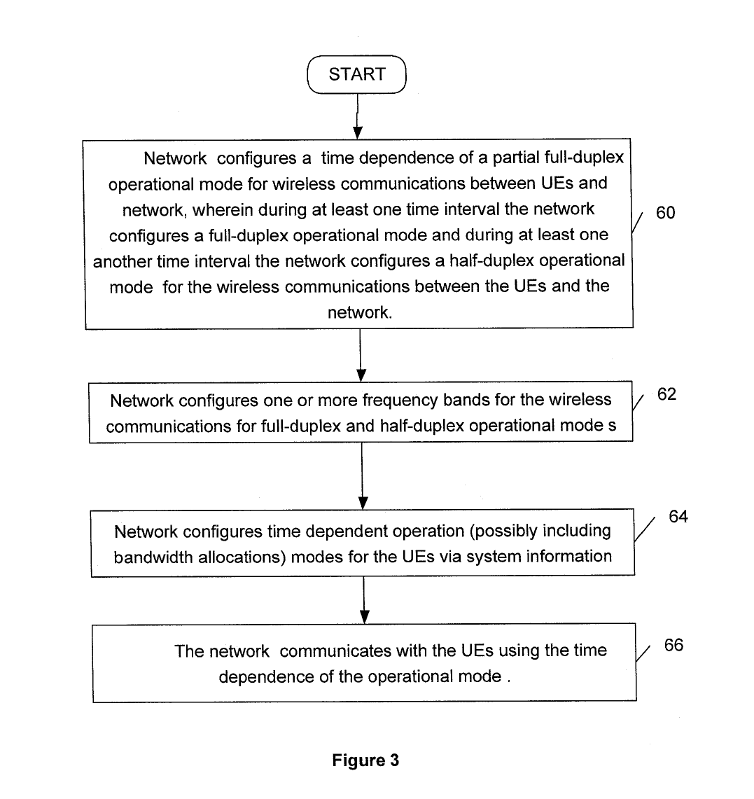

In a method according to this exemplary embodiment, as shown in FIG. 3, in a first step 60, the network configures a time dependence of a partial full-duplex operational mode for wireless communications between UEs and the network, wherein during at least one time interval the network configures a full-duplex operational mode and during at least one another time interval the network configures a half-duplex operational mode for the wireless communications between the UEs and the network (e.g., see FIG. 1). In a next step 62, the network configures one or more frequency bands for the wireless communications for full-duplex and half-duplex operational modes, as explained herein, e.g., see FIG. 2. Step 62 may be skipped if the frequency band for the wireless communications between the UEs and the network is preset.

The results of the a time dependence of the partial full-duplex operational mode of steps 60 and 62 in FIG. 3 may be configured by the network to the UE via system information in step 64. In a next step 66, the network communicates with the UEs using the configured time dependence of the operational mode.

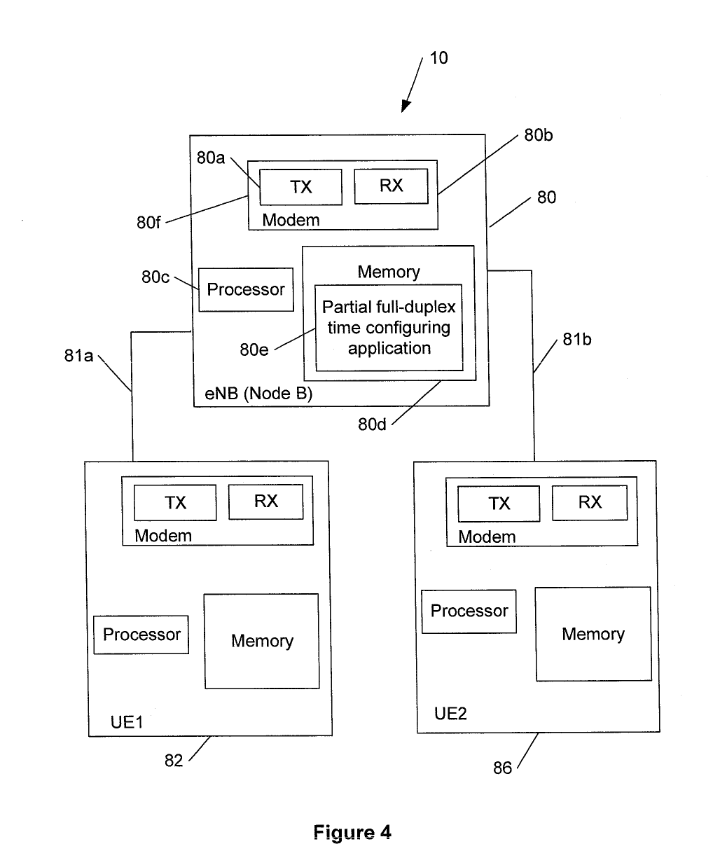

FIG. 4 shows an example of a block diagram demonstrating LTE devices including an eNB 80 comprised in a network 10, and UE1 82 and UE2 86, according to an embodiment of the invention. FIG. 4 is a simplified block diagram of various electronic devices that are suitable for practicing the exemplary embodiments of this invention, e.g., in reference to FIGS. 1-2, and a specific manner in which components of an electronic device are configured to cause that electronic device to operate. Each of the UEs 82 and 86 may be implemented as a mobile phone, a wireless communication device, a camera phone, a portable wireless device and the like.

The eNB 80 may comprise, e.g., at least one transmitter 80a at least one receiver 80b, at least one processor 80c at least one memory 80d and a partial full-duplex time configuring application module 80e. The transmitter 80a and the receiver 80b and corresponding antennas (not shown in FIG. 4) may be configured to provide wireless communications with the UEs 82 and 86 (and others not shown in FIG. 4) according to the embodiment of the invention. The transmitter 80a and the receiver 80b may be generally means for transmitting/receiving and may be implemented as a transceiver, or a structural equivalence (equivalent structure) thereof. It is further noted that the same requirements and considerations are applied to transmitters and receivers of the devices 82 and 86.

Furthermore, the eNB 80 may further comprise communicating means such as a modem 80f, e.g., built on an RF front end chip of the eNB 80, which also carries the TX 80a and RX 80b for bidirectional wireless communications via data/control/broadcasting wireless links 81a and 81b with the UEs 82 and 86. The same concept is applicable to UE devices 82 and 86 shown in FIG. 4.

Various embodiments of the at least one memory 80d (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 80c include but are not limited to general purpose computers, special purpose computers, microprocessors, digital signal processors (DSPs) and multi-core processors. Similar embodiments are applicable to memories and processors in other devices 82 and 86 shown in FIG. 4.

The partial full-duplex time configuring application module 80e may provide various instructions for performing steps 60-66 in FIG. 3. The module 80e may be implemented as an application computer program stored in the memory 80d, but in general it may be implemented as software, firmware and/or hardware module or a combination thereof. In particular, in the once of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 80e may be implemented as a separate block or may be combined with any other module/block of the eNB 80, or it may be split into several blocks according to their functionality.

The UE1 82 and UE2 86 may have similar components as the eNB 80, as shown in FIG. 4, so that the above discussion about components of the eNB 80 is fully applicable to the components of the UE1 82 and UE2 86.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

1. A method, comprising:
configuring by a network a time dependence of a partial full-duplex operational mode for wireless communications between user equipments and the network, wherein during at least one time interval the network configures a full-duplex operational mode and during at least one other time interval the network configures a half-duplex operational mode for the wireless communications between the user equipments and the network; and
communicating with the user equipments using the time dependence of the partial full-duplex operational mode.

2. The method of claim 1, wherein the wireless communications is on one or more frequency bands, wherein the one or more frequency bands comprise a deployment bandwidth or an allocated region of the deployment bandwidth of the wireless communications between the user equipments and the network.

3. The method of claim 1, wherein the full-duplex operational mode and the half-duplex operational mode are configured for at least one user equipment of the user equipments.

4. The method of claim 1, wherein the full-duplex operational mode and the half-duplex operational mode are configured at least for an eNB of the network for communicating with the user equipments.

5. The method of claim 1, wherein the network configures the half-duplex operational mode for one or more user equipments in a cell if the one or more user equipments in the cell are closer than a predefined distance to a cell boundary, so that the one or more user equipments are configured to receive a downlink signal from the network when in the half-duplex operational mode.

6. The method of claim 1, wherein the half-duplex operational mode configured during the at least one other time interval is for reducing interference effects during signal detection by the user equipments.

7. The method of claim 1, wherein the network configures the half-duplex operational mode for the user equipments during receiving by the user equipments scheduling information for one or more next frames.

8. The method of claim 1, wherein during one time interval the network configures a full-duplex operational mode for a portion of the user equipments comprised in a cell and located more than a predefined distance from a cell boundary, and a half-duplex operational mode for a remaining portion of the user equipments comprised in the cell and located less than a predefined distance from the cell boundary.

9. The method of claim 1, wherein during the at least one time interval the network configures the full-duplex operational mode for a first frequency band and during the at least one other time interval the network configures the half-duplex operational mode for a second frequency band.

10. The method of claim 9, wherein the second frequency band is broader than the first frequency band.

11. The method of claim 1, wherein during the at least one time interval the network configures the half-duplex operational mode in a first frequency band for one group of user equipments and a sleeping mode of operation for a further group of half-duplex user equipments.

12. The method of claim 11, wherein during the at least one other time interval the network configures, in a frequency band broader than the first frequency band, the half-duplex operational mode for the first group of user equipments and for the further group of the half-duplex user equipments.

13. The method of claim 12, where transmitting and receiving periods of the one group of the user equipments coincide with corresponding transmitting and receiving periods of the further group of the half-duplex user equipments to minimize signal interference.

14. An apparatus comprising:
at least one processor and a memory storing a set of computer instructions, in which the processor and the memory storing the computer instructions are configured to cause the apparatus to:
configure a time dependence of a partial full-duplex operational mode for wireless communications between user equipments and the apparatus, wherein during at least one time interval the apparatus is adapted to configure a full-duplex operational mode and during at least one other time interval the apparatus is adapted to configure a half-duplex operational mode for the wireless communications between the user equipments and the network; and
communicate with the user equipments using the time dependence of the partial full-duplex operational mode.

15. The apparatus of claim 14, wherein the wireless communications is on one or more frequency bands, wherein the one or more frequency bands comprise a deployment bandwidth or an allocated region of the deployment bandwidth of the wireless communications between the user equipments and the network.

16-17. (canceled)

18. The apparatus of claim 14, wherein the apparatus is adapted to configure the half-duplex operational mode for one or more user equipments in a cell if the one or more user equipments in the cell are closer than a predefined distance to a cell boundary, so that the one or more user equipments are configured to receive a downlink signal from the apparatus when in the half-duplex operational mode.

19. The apparatus of claim 14, wherein the apparatus is adapted to configure the half-duplex operational mode for the user equipments during receiving scheduling information for one or more next frames.

20. The apparatus of claim 14, wherein during one time interval the apparatus is adapted to configure a full-duplex operational mode for a portion of the user equipments comprised in a cell and located more than a predefined distance from a cell boundary, and a half-duplex operational mode for a remaining portion of the user equipments comprised in the cell and located less than a predefined distance from the cell boundary.

21. The apparatus of claim 14, wherein during the at least one time interval the apparatus is adapted to configure the full-duplex operational mode for a first frequency band and during the at least one other time interval the network configures the half-duplex operational mode for a second frequency band.

22. (canceled)

23. The apparatus of claim 14, wherein during the at least one time interval the apparatus is adapted to configure the half-duplex operational mode in a first frequency band for one group of user equipments and a sleeping mode of operation for a further group of half-duplex user equipments.

24. (canceled)

25. A computer readable medium comprising a set of instructions, which, when executed on an apparatus in a network causes the apparatus to perform the steps of:
configuring a time dependence of a partial full-duplex operational mode for wireless communications between user equipments and the network, wherein during at least one time interval the apparatus configures a full-duplex operational mode and during at least one other time interval the apparatus configures a half-duplex operational mode for the wireless communications between the user equipments and the network; and
communicating with the user equipments using the time dependence of the partial full-duplex operational mode.

26-27. (canceled)
